(19) United States
(12) Patent Application Publication
(10) Pub. No.: US 2016/0125290 A1
(43) Pub. Date: May 5, 2016

(54) COMBINED DISCRETE AND INCREMENTAL OPTIMIZATION IN GENERATING ACTIONABLE OUTPUTS

(71) Applicant: Microsoft Technology Licensing, LLC, Redmond, WA (US)

(72) Inventors: Wolf Kohn, Seattle, WA (US); Zelda B. Zabinsky, Seattle, WA (US); Rekha Nanda, Redmond, WA (US)

(21) Appl. No.: 14/528,836

(22) Filed: Oct. 30, 2014

(51) Int. Cl. G06N 5/02; G06N 99/00

(52) U.S. Cl. CPC G06N 5/02; G06N 99/005

(57) ABSTRACT

An optimization solver divides time-indexed historical data into intervals that have temporal boundaries. A discrete coefficient evaluator calculates coefficient values in a forecasting model at the temporal boundaries of the training data. An incremental parameter evaluator evaluates incremental parameter changes between the temporal boundaries in the training data. The incremental parameter evaluator updates the parameter values, based upon the incremental changes in the parameters, so that the updated parameter values can be used by the discrete coefficient evaluator for evaluating coefficient values at a next temporal boundary. The trained forecasting modes is deployed in a system to forecast phenomena.

### BACKGROUND

Computer systems are currently in wide use. Many computer systems use models to generate actionable outputs.

By way of example, some computer systems include business systems. Business systems can include, for instance, customer relations management (CRM) systems, enterprise resource planning (ERP), line-of-business (LOB) systems, among others. These types of systems sometimes attempt to model various processes and phenomena that occur in conducting the business of an organization that deploys the system.

Such models can be relatively complicated. For instance, some organizations may sell millions of different variations of different products. Each such product can be represented by a stock keeping unit (SKU). By way of example, a department store may sell shoes. There may be hundreds of different styles of shoes, each of which comes in many different sizes, many different colors, etc. Each of these variations can have its own SKU. Many models have parameters that need to be estimated from historical data. An example of forecasting demand, by finding parameters based on historical demand. Such systems are relatively complicated.

The discussion above is merely provided for general background information and is not intended to be used as an aid in determining the scope of the claimed subject matter.

### SUMMARY

An optimization solver divides time-indexed historical data into intervals that have temporal boundaries. A discrete coefficient evaluator calculates coefficient values in a forecasting model at the temporal boundaries of the training data. An incremental parameter evaluator evaluates incremental parameter changes between the temporal boundaries in the training data. The incremental parameter evaluator updates the parameter values, based upon the incremental changes in the parameters, so that the updated parameter values can be used by the discrete coefficient evaluator for evaluating coefficient values at a next temporal boundary. The trained forecasting model is deployed in a system to forecast phenomena.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a business system architecture.

FIG. 2 is a more detailed block diagram of one example of a demand forecasting system.

FIG. 3 is a flow diagram illustrating one example of an overview of the operation of a model generation system shown in FIG. 1.

FIG. 4 is a more detailed block diagram of a combined discrete and incremental optimization system.

FIG. 4A illustrates time intervals.

FIGS. 5A and 5B (collectively referred to as FIG. 5) show a flow diagram illustrating one example of the operation of the combined discrete and incremental optimization system shown in FIG. 4.

FIG. 6 is a block diagram showing one example of the architecture shown in FIG. 1, deployed in a cloud computing architecture.

FIG. 7 is a block diagram of one example of a computing environment.

### DETAILED DESCRIPTION

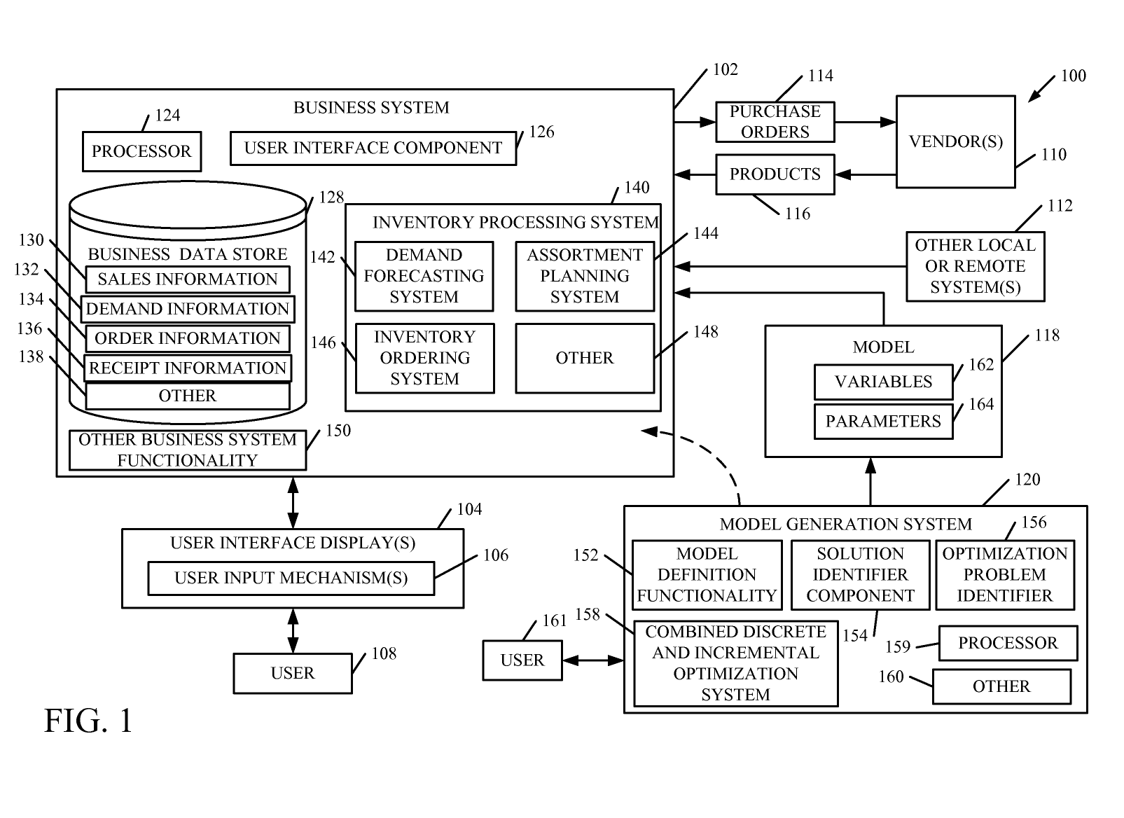

FIG. 1 is a block diagram of one example of a business system architecture 100. Architecture 100 illustratively includes business system 102 that generates user interface displays 104, with user input mechanisms 106, for interaction by user 108. User 108 illustratively interacts with user input mechanisms 106 in order to control and manipulate business system 102, so that user 108 can perform his or her tasks or activities for the organization that uses business system 102.

Architecture 100 also illustratively shows that business system 102 communicates with one or more vendors 110 and can also communicate with other remote systems 112. By way of example, business system 102 can generate and send purchase orders 114 for various products 116, to vendors 110. Those vendors then illustratively send the products 116 to business system 102, where they are sold, consumed or otherwise disposed of.

In the example shown in FIG. 1, business system 102 also illustratively receives a model 118 from model generation system 120. The model can represent various items or trends or forecasts in business system 102. In the example illustrated in FIG. 1, user 161 (who can be the same or different from user 108) can control model generation system 120 to obtain historical data from business system 102 and generate model 118 that can be used to generate forecasts, of different types, for use in business system 102. This can be done automatically as well. In the example described herein, model 118 illustratively generates a demand forecast that indicates demand for various products. The demand forecast can be used by business system 102 in generating purchase orders 114 for submission to vendors 110, in order to obtain products 116 that are used as inventory at business system 102. Of course, it will be noted that model 118 can be a variety of other types of models as well.

In the example shown in FIG. 1, business system 102 illustratively includes processor 124, user interface component 126, business data store 128 (which, itself, illustratively stores time indexed business data, such as sales information 130, demand information 132, order information 134, receipt information 136, and it can include a wide variety of other information 138 as well), inventory processing system 140 (which, itself, includes demand forecasting system 142, assortment planning system 144, inventory ordering system 146, and it can include other items 148), and other business system functionality 150.

FIG. 1 also shows that model generation system 120 illustratively includes model definition functionality 152, solution identifier 154, optimization problem identifier 156, combined discrete and incremental optimization system 158 and output component 159. It can include other items 160.

Before describing one example of the operation of architecture 100 in more detail, a brief overview of some of the items shown in architecture 100 will first be provided. In the example illustrated, the business system functionality 150 is illustratively functionality employed by business system 102 that allows user 108 to perform his or her tasks or activities in conducting the business of the organization that uses business system 102. For instance, where user 108 is a sales person, functionality 150 illustratively allows user 108 to perform workflows, processes, activities and tasks in order to conduct the business of the organization. The functionality can include applications that are run by an application component. The applications can be used to run processes and workflows in business system 102, and to generate various user interface displays 104 that assist user 108 in performing his or her activities or tasks.

Inventory processing system 140 (which can also be part of functionality 150) illustratively uses demand forecasting system 142 to generate a demand forecast. It will be noted that forecasting system 142 is shown as part of business system 102 for the sake of example only, and it could be a remote service or located elsewhere as well. The demand forecast can be used by assortment planning system 144 to plan the assortment of different types of products that are to be purchased by business system 102. Inventory ordering system 146 illustratively generates the purchase orders 114 based upon the forecasted demand output from system 142.

In performing the inventory processing steps, system 140 (including system 142) illustratively has access to historical information stored in business data store 128. It also illustratively stores new information in business data store 128, once that information is generated. For instance, it can store demand forecasts and assortment plans generated by systems 142 and 144. It can store ordering information 134 indicative of orders generated by system 146. It can store receipt information 136 indicative of products 116 received from vendors 110 in response to purchase orders. It can store sales information 130 indicative of sales, etc.

Model generation system 120 is shown, in the example illustrated in FIG. 1, as generating model 118. Model 118 can include model variables 162 and model parameters 164. Model definition functionality 152 illustratively provides functionality (such as by generating user interface displays with user input mechanisms) that allows user 161 to define a model 118. Solution identifier component 154 identifies a solution for which the model parameters 164 can be determined using training data (such as historical information stored in business data store 128). Optimization problem identifier 156 derives a non-linear least squares optimization problem over a given time interval, for determining the parameters that satisfy the identified solution. Combined discrete and incremental optimization system 158 employs a combined discrete and incremental optimization to solve the optimization problem identified by identifier 156. This can be used to identify model parameter values for parameters 164 so that output component 159 can output model 118 to be deployed and used in business system 102.

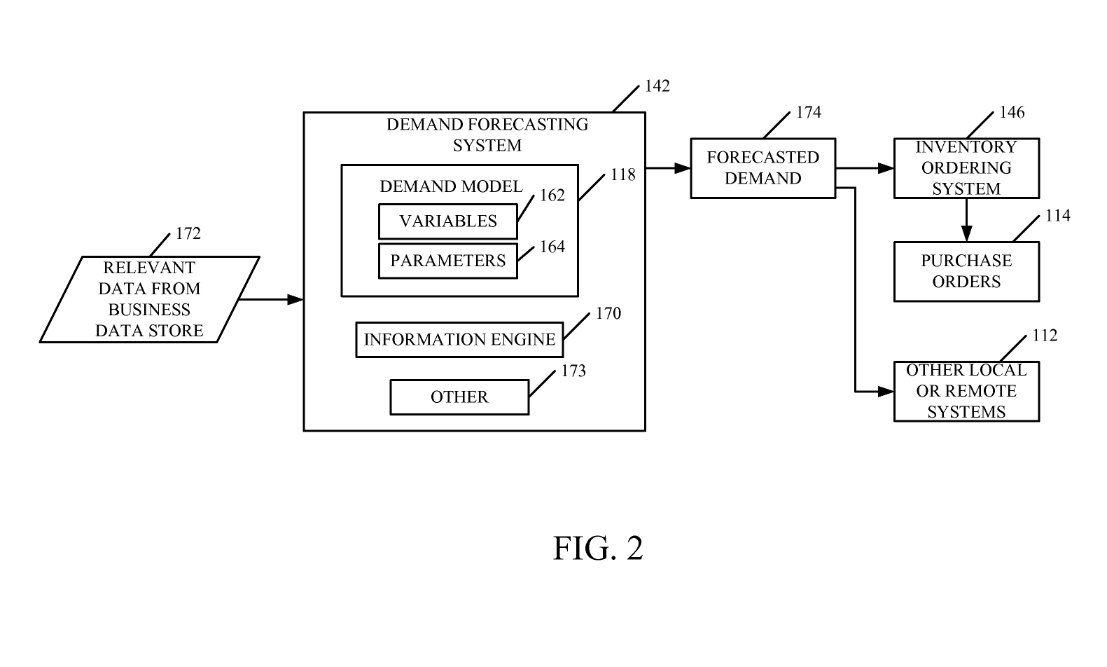

FIG. 2 is a block diagram illustrating one example of demand forecasting system 142 in more detail. Demand forecasting system 142 is shown using model 118. It also includes information engine 170, and it can include other items 173. Once the demand model 118 is developed and trained by system 120, using training data, information engine 170 can illustratively obtain relevant data 172 from business data store 128 that can be used by model 118 to generate a demand forecast 174. Based upon the forecasted demand 174, inventory ordering system 146 illustratively generates the purchase orders 114, which can be provided to vendors 110 in order to obtain products 116. Of course, the forecasted demand can be provided to other local or remote systems 112 as well.

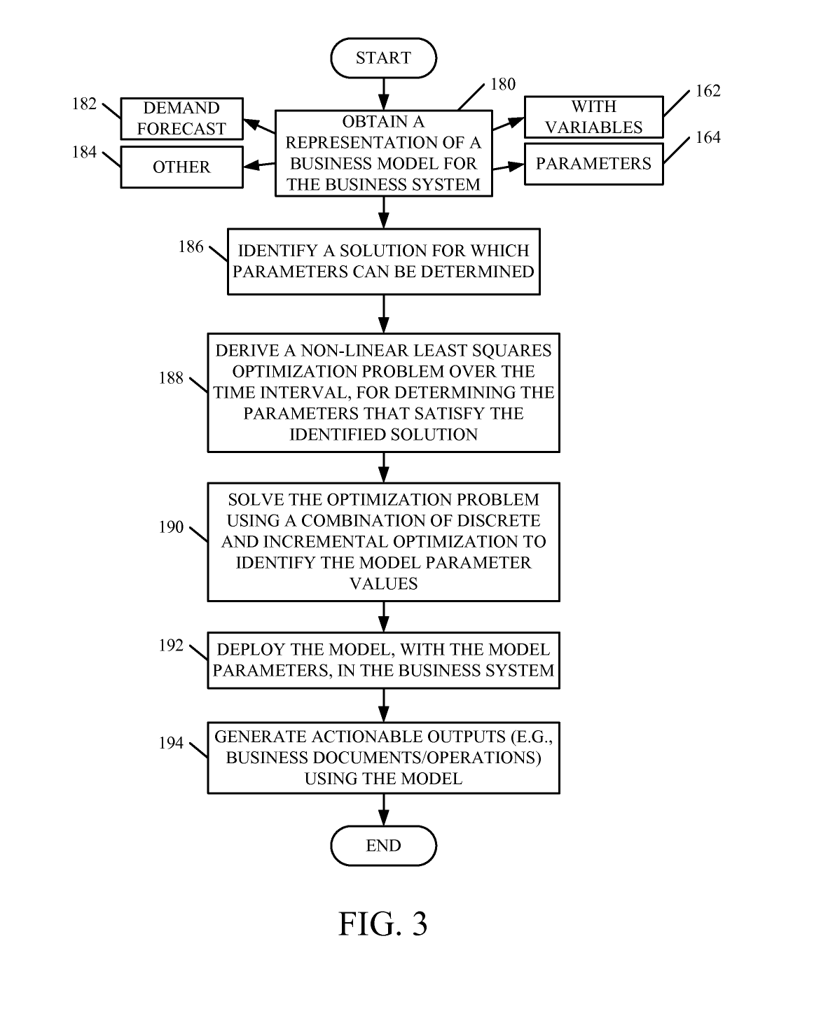

FIG. 3 is a flow diagram illustrating one example of an overview of the operation of model generation system 120 in generating and training model 118. Model definition functionality 152 illustratively generates user interface displays or other functionality that allows user 161 to define a representation of a business model for use in business system 102. This is indicated by block 180 in FIG. 3. As briefly discussed above, the model can be used to generate demand forecasts 182. It can include variables 162 and model parameters 164, and it can include other items 184. One representation of a model 118 is set out below in equation 1.

Solution identifier component 154 then identifies a solution for which parameters 164 can be determined in model 118. This is indicated by block 186 in FIG. 3, and one example of a solution is set out in equation 6 below.

Optimization problem identifier 156 then derives a non-linear least squares optimization problem over a given time interval. This optimization problem is used to determine the parameters that satisfy the identified solution. This is indicated by block 188 and such an optimization problem is represented by equation 8 below.

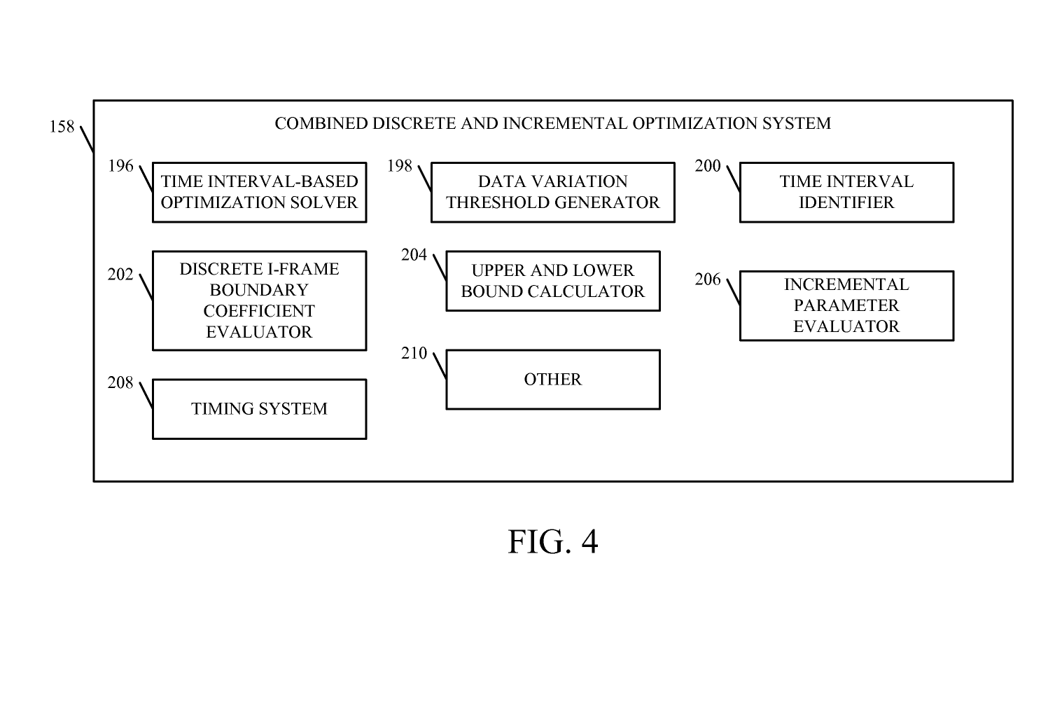

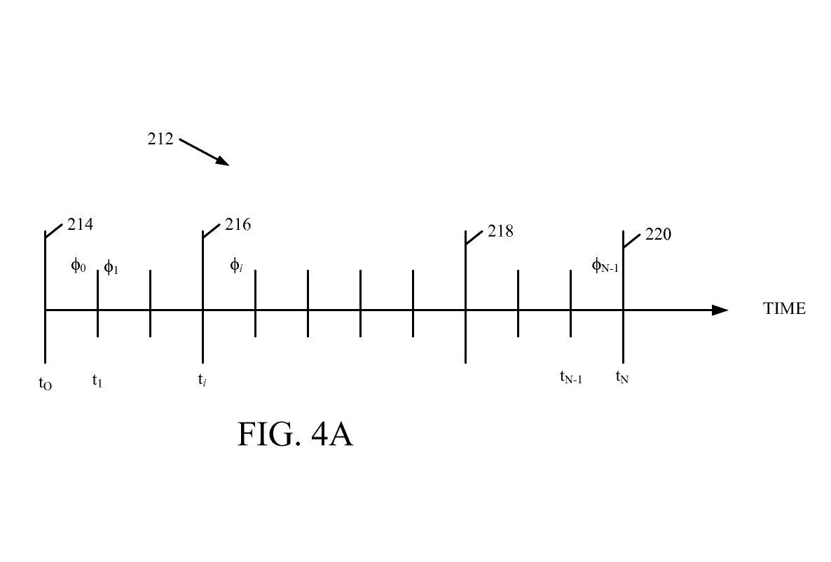

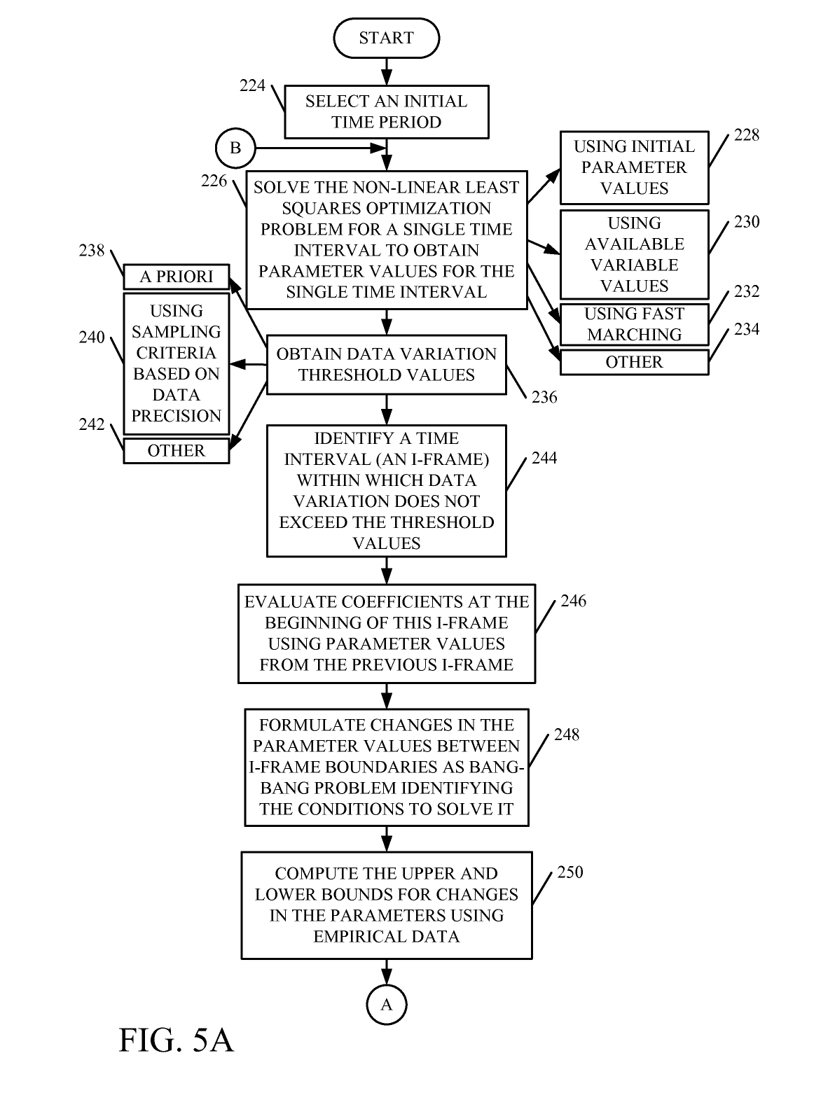

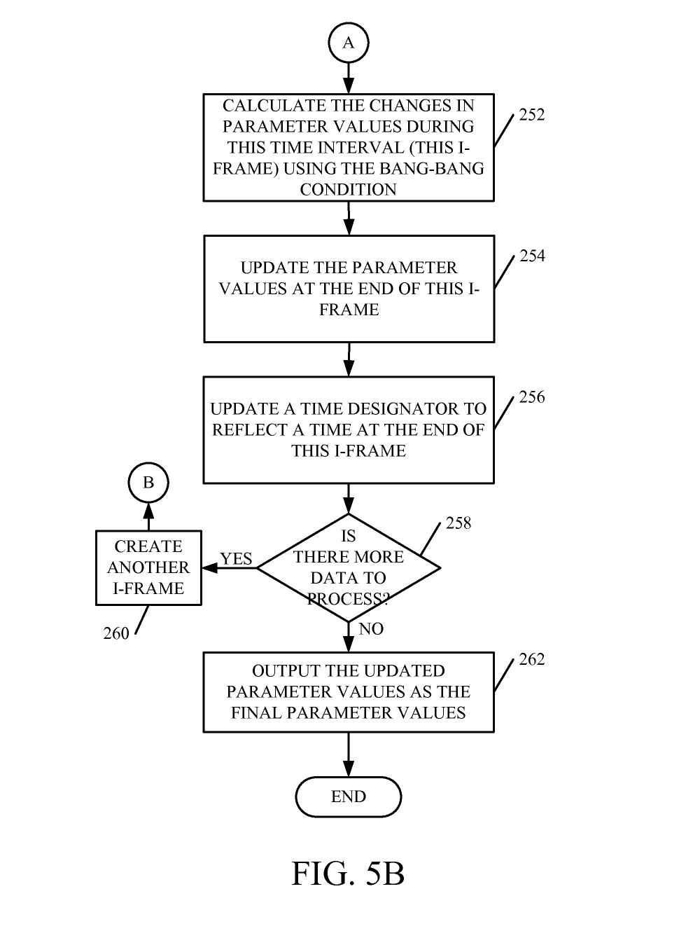

Combined discrete and incremental optimization system 158 then solves the optimization identified in block 188, using a combination of discrete and incremental optimizations, in order to identify the model parameter values for parameters 164. This is indicated by block 190. This is described in greater detail below with respect FIGS. 4-5.

Model generation system 120 then provides the model 118 (with its trained model parameters 164) to business system 102, where it can be deployed. This is indicated by block 192. Business system 102 then uses it (such as in inventory processing system 140, etc.) in order to generate actionable outputs, such as business documents (e.g., purchase orders 114), various operations or other actionable outputs. This is indicated by block 194.

FIG. 4 shows one example of a more detailed block diagram of combined discrete and incremental optimization system 158. A more detailed discussion of some of the items in system 158 will be described, for the sake of one example. In FIG. 4, system 158 illustratively includes time interval-based optimization solver 196, data variation threshold generator 198, time interval identifier 200, discrete I-frame boundary coefficient calculator 202, upper and lower bound calculator 204, incremental parameter evaluator 206, timing system 208, and it can include other items 210.

FIG. 4A shows one example of a timeline 212. Timeline 212 is divided, by boundaries 214, 216, 218, and 220, into time intervals, referred to herein as I-frames. Each of the I-frames can have a plurality of intervals represented by Φ₀-Φ_{N-1}.

Briefly, by way of overview, discrete I-frame boundary coefficient evaluator 202 can be implemented by a microprocessor and its timing circuitry to evaluate the coefficients of the optimization problem derived at block 188 in FIG. 3 above, at the I-frame boundaries 214, 216, 218 and 220. This can be a relatively expensive calculation, and therefore evaluator 202 is only invoked to make the calculation relatively infrequently, such as over a single time interval, at the time interval boundaries. Incremental parameter evaluator 206 can be implemented by a processor and is invoked, between interval boundaries, to evaluate changes in the values of parameters 164 (in model 118) during the timespan within the intervals. Evaluator 206 updates those parameter values, just prior to each time interval boundary, so that the updated parameter values can be used by the discrete I-frame boundary coefficient evaluator 202, when it evaluates the coefficients at the interval boundaries.

FIGS. 5A and 5B (collectively referred to herein as FIG. 5) show one example of a flow diagram illustrating the operation of combined discrete and incremental optimization system 158 in performing these evaluations (as briefly described above with respect to block 190 in FIG. 3). It is assumed that system 158 has already received a model representation (such as the representation in Eq. 1 below) for the model to be trained. It is also assumed that the historical training data has been obtained (or can be obtained) from business data store 128, and that it is time indexed, meaning that the various historical data has been marked with some type of time identifier indicating a time when the data was generated, relative to other training data. For instance, sales information 130 illustratively has a time identifier indicating when the sales represented by information 130 were made. Order information 134 illustratively includes a time identifier indicating when orders represented by information 134 were placed, etc.

Time interval identifier 200 accesses the historical information and selects an initial time period. This is indicated by block 224 in FIG. 5. The time interval-based optimization solver 196 is then invoked to solve the non-linear least squares optimization problem for the single time interval which was initially identified, in order to obtain parameter values for the single time interval. This is indicated by block 226. Solver 196 illustratively does this by loading initial parameter values 228, and available variable values from the historical data as represented by 230. It can use a fast marching algorithm 232 to process the loaded data. It can do this in other ways 234 as well. This computation can be represented by equation 9 below. It can be a relatively expensive computation in terms of processing and memory overhead, and in terms of time. That is, the solver 196 can consume computing resources in generating the optimization and it can take a relatively long time, relative to the incremental updates. Therefore, it is only performed, at this point, for the initial time period identified at block 224.

Data variation threshold generator 198 is then invoked to generate a data variation threshold. This is indicated by block 236. The data variation threshold is a threshold value, by which the historical data for the variables can vary, before another time interval boundary is set. It will be noted that the data variation threshold values can be calculated a priori as indicated by block 238. They can be calculated using sampling criteria based on data precision, as indicated by block 240, or they can be calculated in a wide variety of other ways, as indicated by block 242.

Time interval identifier 200 then identifies another time interval (e.g., an I-frame) within which the historical data variation does not exceed the threshold values obtained in block 236. Identifying the time interval (e.g., I-frame) is indicated by block 244.

Discrete I-frame boundary coefficient evaluator 202 is then invoked to evaluate the coefficients of the optimization at the beginning of this I-frame, using the parameter values from an immediately previous I-frame (if any). Again, because this is a relatively expensive computation, evaluator 202 is only invoked to perform it at the I-frame boundaries. Invoking evaluator 202 to evaluate the coefficients in this way is indicated by block 246.

Evaluator 202 can also identify changes in the parameter values between the I-frame boundaries as a bang-bang problem, and it can identify the conditions that can be used to solve that problem. This is indicated by block 248 in FIG. 5. By way of example, formulating changes in the parameter values as a bang-bang problem is represented by equation 18 below, and the conditions to solve the problem are indicated by equations 30-32.

Upper and lower bound calculator 204 computes the upper and lower bounds for changes in the parameters using empirical data. This is indicated by block 250.

Incremental parameter evaluator 206 then calculates the changes in parameter values during this time interval (e.g., during this I-frame) using the bang-bang conditions identified at block 248 above, and using the upper and lower bounds as calculated at block 250. This is indicated by block 252. Evaluator 206 then updates the parameter values at the end of this I-frame, based upon the changes computed at block 252. This is indicated by block 254.

Timing system 208 then updates a time designator to reflect a time at the end of this I-frame, and relative to the time-stamped (or time-indexed) historical data obtained from business data store 128. Updating the time designator is indicated by block 256 in FIG. 5.

System 258 then determines whether there is any more historical data to process. This is indicated by block 258. By way of example, if additional, more recent, historical data is still stored in data store 128, and has yet to be processed by system 158, then time interval identifier 200 creates another I-frame, as indicated by block 260, and processing reverts back to block 226 where the non-linear least squares optimization problem is solved for that I-frame. However, if, at block 258, all of the desired historical data has been evaluated, then system 158 outputs the updated parameter values for parameters 164 in model 118, as the final parameter values. This is indicated by block 262. The model 118 can then be deployed in business system 102 as discussed above.

A more formal description of using the combined discrete and incremental optimization to obtain the final model parameters will now be provided.

As mentioned above, a fast marching algorithm and the I-frame approach are deployed to approximate the least squares optimization of the model parameters. In some systems, the fast marching algorithm uses a numerical estimate of the gradient, which requires a large number of function evaluations. The present discussion describes an approximation to the gradient, with respect to the parameters being optimized, in the fast marching algorithm and only evaluates it at I-frame intervals. This reduces the number of times the function is evaluated, which improves efficiency because it is very costly in terms of computation time.

Equation 1 below represents one example of forecaster model for demand:

dx=[A₀+A₁u(t)]x(t)dt+Bu(t)dt+Cf(t)dt+dω(t) Eq. 1

where x(t) is the demand, u(t) is the order amount, f(t) is the index at time t which is known from the historical data, B is known and the expectation of the noise term, ω(t), is zero. A₀, A₁, B, and C are model parameters.

It is assumed that A₀, A₁, B, and C are constant over [tᵢ, tᵢ₊₁). For sufficiently small intervals, u(τ)=uᵢδ(τ−tᵢ) for τ∈[tᵢ, tᵢ₊₁), where δ is the Dirac delta function and uᵢ is the observed order amount at time tᵢ. Let Aᵢ=A₀+A₁uᵢ. The index is constant, f(τ)=f(tᵢ) for τ∈[tᵢ, tᵢ₊₁).

In order for the system to be stable, (Aᵢ, B) needs to be controllable. In the controller, it is assumed that B is equal to a small number, if the system is not controllable. For stability, |A₀+A₁uᵢ|<0. Note that in the least squares formulation, no constraint is included for stability.

The system finds values for A₀, A₁, C, with B≈0, such that Eq. 1 is a good forecast. For the purpose of testing, the system uses POS(t−1) for u(t), POS(t) for x(t), and POS(t−2) for the index f(t).

First, an analytical solution for x(t) in equation 1 is derived. Integrating both sides of equation 1 over a time interval [tᵢ, tᵢ₊₁] leads to

$$\begin{matrix}x ( {t}_{i + 1} ) = {e}^{{A}_{i} ( {t}_{i + 1} - {t}_{i} )} x ( {t}_{i} ) + {\int }_{{t}_{i}}^{{t}_{i + 1}} {e}^{{A}_{i} ( {t}_{i + 1} - τ )} Bu ( τ ) d τ + {\int }_{{t}_{i}}^{{t}_{i + 1}} {e}^{{A}_{i} ( {t}_{i + 1} - τ )} Cf ( τ ) d τ , & Eq . 2 \\ x ( {t}_{i + 1} ) = {e}^{{A}_{i} ( {t}_{i + 1} - {t}_{i} )} x ( {t}_{i} ) + B {e}^{{A}_{i} {t}_{i + 1}} {\int }_{{t}_{i}}^{{t}_{i + 1}} {e}^{- {A}_{i} τ} {u}_{i} δ ( τ - {t}_{i} ) d τ - \frac{{e}^{{A}_{i} {t}_{i + 1}}}{{A}_{i}} {e}^{{- {A}_{i} τ \vert}_{{t}_{i}}^{{t}_{i + 1}}} Cf ( {t}_{i} ) & Eq . 3 \\ x ( {t}_{i + 1} ) = {e}^{{A}_{i} ( {t}_{i + 1} - {t}_{i} )} x ( {t}_{i} ) + B {e}^{{A}_{i} {t}_{i + 1}} {e}^{- {A}_{i} {t}_{i}} {u}_{i} - \frac{{e}^{{A}_{i} {t}_{i + 1}}}{A} ( {e}^{- {A}_{i} {t}_{i} + 1} - {e}^{- {A}_{i} {t}_{i}} ) Cf ( {t}_{i} ) & Eq . 4 \\ x ( {t}_{i + 1} ) = {e}^{{A}_{i} ( {t}_{i + 1} - {t}_{i} )} x ( {t}_{i} ) + B {e}^{{A}_{i} {t}_{i + 1}} {e}^{- {A}_{i} {t}_{i}} {u}_{i} - \frac{1}{{A}_{i}} ( 1 - {e}^{{A}_{i} ( {t}_{i + 1} - {t}_{i} )} ) Cf ( {t}_{i} ) . & Eq . 5\end{matrix}$$

Letting Δtᵢ=tᵢ₊₁−tᵢ and collecting terms yields,

$$x ( {t}_{i + 1} ) - [ {e}^{{A}_{i} Δ {t}_{i}} x ( {t}_{i} ) + B {e}^{{A}_{i} Δ {t}_{i}} {u}_{i} - \frac{1}{{A}_{i}} ( 1 - {e}^{- {A}_{i} Δ {t}_{i}} ) Cf ( {t}_{i} ) ] = 0. \qquad Eq . 6$$

The system has a goal to find A₀, A₁ and C that satisfy equation 6. Formally, a new function φᵢ(tᵢ₊₁, tᵢ, xᵢ₊₁, xᵢ, uᵢ, A₀, A₁, C) is defined equal to the left hand side of equation 6, where xᵢ is the observed order amount at time tᵢ, xᵢ₊₁ is the observed demand at time tᵢ₊₁, uᵢ is the observed demand at time tᵢ, Δtᵢ=tᵢ₊₁−tᵢ and Aᵢ=A₀+A₁uᵢ. Also, B and f(tᵢ) are assumed to be given. This gives:

$${φ}_{i} ( {t}_{i + 1} , {t}_{i} , {x}_{i + 1} , {x}_{i} , {u}_{i} , {A}_{0} , {A}_{1} , C ) = {x}_{i + 1} - [ {e}^{{A}_{i} Δ {t}_{i}} {x}_{i} + B {e}^{{A}_{i} Δ {t}_{i}} {u}_{i} - \frac{1}{{A}_{i}} ( 1 - {e}^{- {A}_{i} Δ {t}_{i}} ) Cf ( {t}_{i} ) ] . \qquad Eq . 7$$

Note if Aᵢ=0 then l'Hospital's Theorem is used for determining Aᵢ=A₀ⁱ+A₁ⁱuᵢ

The following nonlinear least squares optimization problem is defined over the time interval [t₀, t_{N}],

$${min}_{{A}_{0} , {A}_{1} , C} {\sum }_{i = 0}^{N - 1} {φ}_{i}^{2} ( {t}_{i + 1} , {t}_{i} , {x}_{i + 1} , {x}_{i} , {u}_{i} , {A}_{0} , {A}_{1} , C ) . \qquad Eq . 8$$

Classical least squares algorithms for solving the problem in equation 8 are computationally costly, requiring a large number of function evaluations. The approach using I-frames is to reduce the computation by only doing expensive evaluations occasionally, at I-frame intervals.

The present model generation system 120 uses combined discrete and incremental optimization system 158 to implement the approximation via the hybridization of two optimization procedures: a discrete optimization procedure referred to as the I-frame optimization and a continuous incremental optimization procedure referred to as the incremental optimization.

The approach to solve the least squares problem in equation 8 is thus to restrict the large computation to the start of I-frames, and to continualize and linearize the “flow information” between I-frames.

The I-frame optimization problem is to solve,

$${min}_{{A}_{0} , {A}_{1} , C} {φ}_{i}^{2} ( {t}_{i + 1} , {t}_{i} , {x}_{i + 1} , {x}_{i} , {u}_{i} , {A}_{0} , {A}_{1} , C ) \qquad Eq . 9$$

for one time interval only, the time corresponding to the start of an I-frame. A fast marching algorithm is used to solve equation 9, and use the expressions for the partial derivatives of φᵢ² with respect to the parameters A₀, A₁, and C as given below. The values of tᵢ₊₁, tᵢ, xᵢ₊₁, xᵢ, and uᵢ are available from data store 128. Note that initial values, or ranges, for A₀, A₁, and C are obtained in order to start the fast marching algorithm.

Now considering an I-frame interval, denote the I-frame starting at time tₖ as the kth I-frame, and use t as the “time” of an I-frame, t≧0.

Define a continualized form of φᵢ on the kth I-frame interval (k=i), with a linear perturbation of the model parameters that is based on Euler's integration algorithm. It is,

$${\tilde{φ}}_{t} ( {t}_{k + 1} , {t}_{k} , {x}_{k + 1} , {x}_{k} , {u}_{k} , {A}_{0}^{k} , {A}_{1}^{k} , {C}^{k} , δ {A}_{0}^{k} ( t ) , δ {A}_{1}^{k} ( t ) , δ {C}^{k} ( t ) ) = {x}_{k + 1} - [ {e}^{{\tilde{A}}_{k} ( t ) Δ {t}_{k}} {x}_{k} + B {e}^{{\tilde{A}}_{k} ( t ) Δ {t}_{k}} {u}_{k} - \frac{1}{{\tilde{A}}_{k} ( t )} ( 1 - {e}^{- {\tilde{A}}_{k} ( t ) Δ {t}_{k}} ) \tilde{C} ( t ) f ( {t}_{k} ) ] \qquad Eq . 10$$

where Δtₖ=tₖ₊₁−tₖ and Ãₖ(t)=A₀^{k}+δA₀^{k}(t)+(A₁^{k}+δA₁^{k}(t))uₖ and \tilde{C}(t)=C^{k}+δCkt.

For ease of notation, for the kth I-frame, let Fₖ=tₖ₊₁, tₖ, xₖ₊₁, xₖ, uₖ, A₀^{k}, A₁^{k}, C^{k}, and write \tilde{φ}ₜ(Fₖ, δA₀^{k}(t), δA₁^{k}(t), δC^{k}(t)). At the beginning of the kth I-frame, values for Fₖ are readily available; values for tᵢ₊₁, t₁, xᵢ₊₁, xᵢ, and uᵢ are available from the data, in data store 128 and values for A₀^{k}, A₁^{k}, and C^{k} are available from the solution to equation 9.

Because the variation in the data (e.g., xₖ₊₁, xₖ, uₖ) is small within an I-frame, next approximate \tilde{φ}ₜ² with a first order Taylor series expansion around the values of the data at the I-frame. Choose to approximate \tilde{φ}ₜ² to compare against the least squares formulation. This yields:

$$Eq . 11$$

$${\tilde{φ}}_{t}^{2} ( {F}_{k} , δ {A}_{0}^{k} ( t ) , δ {A}_{1}^{k} ( t ) , δ {C}^{k} ( t ) ) \approx {\tilde{φ}}_{T = 0}^{2} ( {F}_{k} , δ {A}_{0}^{k} ( 0 ) , δ {A}_{1}^{k} ( 0 ) , δ {C}^{k} ( 0 ) ) + \frac{\partial {\tilde{φ}}_{t}^{2}}{\partial {A}_{0}} {\vert}_{{F}_{k}^{-}} \cdot δ {A}_{0}^{k} ( t ) + \frac{\partial {\tilde{φ}}_{t}^{2}}{\partial {A}_{1}} {\vert}_{{F}_{k}^{-}} \cdot δ {A}_{1}^{k} ( t ) + \frac{\partial {\tilde{φ}}_{t}^{2}}{\partial C} {\vert}_{{F}_{k}^{-}} \cdot δ {C}^{k} ( t )$$

and, again, for ease of notation, let Yₖ=\tilde{φ}ₜ₌₀²(Fₖ, δA₀^{k}(0), δA₁^{k}(0), δC^{k}(0)) and let

$${Z}_{k} = [ {Z}_{k , 1} , {Z}_{k , 2} , {Z}_{k , 3} ] = [ \frac{\partial {\tilde{φ}}_{t}^{2}}{\partial {A}_{0}} {\vert}_{{F}_{k}^{-}} , \frac{\partial {\tilde{φ}}_{t}^{2}}{\partial {A}_{1}} {\vert}_{{F}_{k}^{-}} , \frac{\partial {\tilde{φ}}_{t}^{2}}{\partial C} {\vert}_{{F}_{k}^{-}} ]$$

and let δV^{k}(t)=[δA₀^{k}(t), δA₁^{k}(t), δC^{k}(t)]^{T} yielding:

\tilde{φ}ₜ²(Fₖ, δA₀^{k}(t), δA₁^{k}(t), δC^{k}(t))≈Yₖ+ZₖδV^{k}(t). Eq. 12

Note that Yₖ and Zₖ are computed by evaluator 202 only at the beginning of an I-frame. Because δA₀^{k}(0), δA₁^{k}(0) and δC^{k}(0) are equal to zero, Yₖ=φₖ². Expressions for the calculating Zₖ are given in the final Gradient Calculations section of the description below. The approximation is linear in δV^{k}(t).

Next, the least squares problem in equation 8 is viewed as a partial summing formulation, in order to make use of the approximation in equation 10 to \tilde{φ}ₜ²(Fₖ, δA₀^{k}(t), δA₁^{k}(t), δC^{k}(t)). Using a partial summing formulation, the optimization problem in equation 8 can be written in the following recursive form:

$${min}_{{A}_{0} , {A}_{1} , C} {S}_{N} \\ subject to {S}_{i + 1} = {S}_{i} + {φ}_{i}^{2} ( {t}_{i + 1} , {t}_{i} , {x}_{i + 1} , {x}_{i} , {u}_{i} , {A}_{0} , {A}_{1} , C ) \\ for i = 0 , … , N - 1 , \qquad Eq . 13$$

with initial condition S₀=0.

Equation 13 can be readily continualized to obtain the following continuous time approximation on the current kth I-frame. Define

$${\dot{\tilde{S}}}_{k} ( t ) = \frac{d {\tilde{s}}_{k} ( t )}{d t} = α {\tilde{φ}}_{t}^{2} ( {F}_{k} , δ {A}_{0}^{k} ( t ) , δ {A}_{1}^{k} ( t ) , δ {C}^{k} ( t ) ) \qquad Eq . 14$$

for t≧0. The parameter α is called a Riemann descent parameter and is a function of 1/Δ. There are numerical methods for estimating the parameter, but they are not needed, because the parameter α cancels in the later development. Linearize around t to obtain,

\tilde{S}ₖ(t)=\tilde{S}ₖ(0)+δ\tilde{S}ₖ(t) Eq. 15

where \tilde{S}ₖ(0)=Sₖ. Taking derivatives of both sides of equation 15 yields,

{tilde over (\dot{S}ₖ(t)={tilde over (\dot{S}ₖ(0)+δ{tilde over (\dot{S}ₖ(t) Eq. 16

where {tilde over (\dot{S}ₖ(0)=0. From equations 14 and 16, a linear differential equation with constant coefficients is obtained as:

$$\begin{matrix}δ {\dot{\tilde{S}}}_{k} ( t ) = α {\tilde{φ}}_{t}^{2} ( {F}_{k} , δ {A}_{0}^{k} ( t ) , δ {A}_{1}^{k} ( t ) , δ {C}^{k} ( t ) ) \\ \approx α ( {Y}_{k} + {Z}_{k} δ {V}^{k} ( t ) ) .\end{matrix} \qquad Eq . 17$$

Now a linear control problem can be written to find δV^{k}(t)=[δA₀^{k}(t), δA₁^{k}(t), δC^{k}(t)]^{T} in between I-frames. The interval of the kth I-frame is illustratively as long as possible, so the time of the interval is maximized, while the error at the terminal time, δ\tilde{S}ₖ(T), is minimized. Note that δ\tilde{S}ₖ(T) is always greater than or equal to zero, because it is approximating the squared error φᵢ². The linear control problem is:

$${max}_{δ {V}^{k}} {\int }_{0}^{T} 1 d s - q δ {\tilde{S}}_{k} ( T ) \\ subject to \\ δ {\dot{\tilde{S}}}_{k} ( t ) = α ( {Y}_{k} + {Z}_{k} δ {V}^{k} ( t ) ) \\ δ {A}_{{0}_{min}} \leq δ {A}_{0} \leq δ {A}_{{0}_{max}} \\ δ {A}_{{1}_{min}} \leq δ {A}_{1} \leq δ {A}_{{1}_{max}} \\ δ {C}_{min} \leq δ C \leq δ {C}_{max} \qquad Eq . 18$$

where q is a weighting parameter, q>0. Problem 18 is a bang-bang problem. Also, there will be at most one switching point in the interval [0, T]. There are many ways to determine the values of the upper and lower bounds on the controls A₀_{ₘᵢₙ}, δA₀_{ₘₐₓ}, δA₁_{ₘᵢₙ}, δA₁_{ₘₐₓ}, δCₘᵢₙ, and δCₘₐₓ from empirical data. For example, the users may choose a desired precision of the forecast.

Next construct the Hamiltonian and solve the necessary conditions of optimality to solve the bang-bang problem. The Hamiltonian is:

H(δ\tilde{S}ₖ, δA₀, δA₁, δC, p)=−1+p(αYₖ+αZₖδV^{k}(t)) Eq. 19

and this gives

$$\begin{matrix}δ {\dot{\tilde{S}}}_{k} ( t ) = \frac{\partial H}{\partial p} = α {Y}_{k} + α {Z}_{k} δ {V}^{k} ( t ) & Eq . 20 \\ and & \\ \dot{p} = - \frac{\partial H}{\partial δ {\tilde{S}}_{k}} = 0 & Eq . 21\end{matrix}$$

which implies that p equals a constant. From

$$p ( T ) = \frac{\partial ( - q δ {\tilde{S}}_{k} ( T ) )}{\partial δ {\tilde{S}}_{k}} = - q \qquad Eq . 22$$

it can be seen that p=−q. The last condition is that

H*(δ\tilde{S}*ₖ, δA*₀, δA*₁, δC*, p)≧H(δ\tilde{S}*ₖ, δA₀, δA₁, δC, p) Eq. 23

which implies that

−1+p(αYₖ+αZₖδV^{k}*(t))≧−1+p(αYₖ+αZₖδV^{k}(t)) pαZₖδV^{k}*(t)≧pαZₖδV^{k}(t) Eq. 24

and canceling terms, and flipping the inequality since p<0, yields the bang-bang condition,

ZₖδV^{k}*(t)≦ZₖδV^{k}(t). Eq. 25

Writing out the terms yields,

$$Eq . {26 \\ [ \frac{\partial {\tilde{φ}}_{t}^{2}}{\partial {A}_{0}} \vert}_{{F}_{k}^{-}} , \frac{\partial {\tilde{φ}}_{t}^{2}}{\partial {A}_{1}} {\vert}_{{F}_{k}^{-}} , \frac{\partial {\tilde{φ}}_{t}^{2}}{\partial C} {\vert}_{{F}_{k}^{-}} ] \cdot [ \begin{matrix}δ {A}_{0}^{k *} ( t ) \\ δ {A}_{1}^{k *} ( t ) \\ δ {C}^{k *} ( t )\end{matrix} ] \leq {{[ \frac{\partial {\tilde{φ}}_{t}^{2}}{\partial {A}_{0}} \vert}_{{F}_{k}^{-}} , \frac{\partial {\tilde{φ}}_{t}^{2}}{\partial {A}_{1}} \vert}_{{F}_{k}^{-}} , \frac{\partial {\tilde{φ}}_{t}^{2}}{\partial C} {\vert}_{{F}_{k}^{-}} ] \cdot [ \begin{matrix}δ {A}_{0}^{k} ( t ) \\ δ {A}_{1}^{k} ( t ) \\ δ {C}^{k} ( t )\end{matrix} ]$$

and term by term,

$$\begin{matrix}{( \frac{\partial {\tilde{φ}}_{t}^{2}}{\partial {A}_{0}} \vert}_{{F}_{k}^{-}} ) δ {A}_{0}^{k *} ( t ) \leq {( \frac{\partial {\tilde{φ}}_{t}^{2}}{\partial {A}_{0}} \vert}_{{F}_{k}^{-}} ) δ {A}_{0}^{k} ( t ) & Eq . 27 \\ {( \frac{\partial {\tilde{φ}}_{t}^{2}}{\partial {A}_{1}} \vert}_{{F}_{k}^{-}} ) δ {A}_{1}^{k *} ( t ) \leq {( \frac{\partial {\tilde{φ}}_{t}^{2}}{\partial {A}_{1}} \vert}_{{F}_{k}^{-}} ) δ {A}_{1}^{k} ( t ) & Eq . 28 \\ {( \frac{\partial {\tilde{φ}}_{t}^{2}}{\partial C} \vert}_{{F}_{k}^{-}} ) δ {C}^{k *} ( t ) \leq {( \frac{\partial {\tilde{φ}}_{t}^{2}}{\partial C} \vert}_{{F}_{k}^{-}} ) δ {C}^{k} ( t ) . & Eq . 29\end{matrix}$$

If the coefficients,

$${{\frac{\partial {\tilde{φ}}_{t}^{2}}{\partial {A}_{0}} \vert}_{{F}_{k}^{-}} , \frac{\partial {\tilde{φ}}_{t}^{2}}{\partial {A}_{1}} {\vert}_{{F}_{k}^{-}} , \frac{\partial {\tilde{φ}}_{t}^{2}}{\partial C} \vert}_{{F}_{k}^{-}} ,$$

are greater than zero then the respective variables, δA₀^{k}*, δA₁^{k}* and δC*, take on their minimum values, and if the coefficients are less than zero then the respective variables, δA₀^{k}*, δA₁^{k}* and δC*, take on their maximum values,

$$\begin{matrix}δ {A}_{0}^{k *} ( t ) = \{ \begin{matrix}δ {A}_{{0}_{min}} & {if \frac{\partial {\tilde{φ}}_{t}^{2}}{\partial {A}_{0}} \vert}_{{F}_{k}^{-}} > 0 \\ δ {A}_{{0}_{max}} & {if \frac{\partial {\tilde{φ}}_{t}^{2}}{\partial {A}_{0}} \vert}_{{F}_{k}^{-}} < 0\end{matrix} & Eq . 30 \\ δ {A}_{1}^{k *} ( t ) = \{ \begin{matrix}δ {A}_{{1}_{min}} & {if \frac{\partial {\tilde{φ}}_{t}^{2}}{\partial {A}_{1}} \vert}_{{F}_{k}^{-}} > 0 \\ δ {A}_{{1}_{max}} & {if \frac{\partial {\tilde{φ}}_{t}^{2}}{\partial {A}_{1}} \vert}_{{F}_{k}^{-}} < 0\end{matrix} & Eq . 31 \\ δ {C}^{k *} ( t ) = \{ \begin{matrix}δ {C}_{min} & {if \frac{\partial {\tilde{φ}}_{t}^{2}}{\partial {A}_{0}} \vert}_{{F}_{k}^{-}} > 0 \\ δ {{A}_{0}}_{max} & {if \frac{\partial {\tilde{φ}}_{t}^{2}}{\partial {A}_{0}} \vert}_{{F}_{k}^{-}} < 0\end{matrix} & Eq . 32\end{matrix}$$

The variables will only switch once during the interval [0, T]. Note that the final time of the kth I-frame, starting at tᵢ, is T=tᵢ₊ⱼ−tᵢ.

To summarize the approach to approximately solving the nonlinear least squares problem in equation 8, begin the initial I-frame at k=0. Solve a one period problem (equation 9), to obtain initial parameters for the incremental model. Then, use the bang-bang principle to get the perturbed values of the parameters just before the next I-frame. There may be several I-frames needed in the [t₀, t_{N}] but each I-frame only computes the coefficients once. At the final I-frame, the values of the parameters can be sent to any desired parameter adaptation engine for further refinement.

FIG. 2. Illustration showing the parameter values at the end of an I-frame.

The components of system 158 are configured to perform the following steps.
1. Start the initial I-frame at time t₀, and set k=0.
2. Solve the following single time period problem

$${min}_{{A}_{0} , {A}_{1} , C} {φ}_{i}^{2} ( {t}_{i + 1} , {t}_{i} , {x}_{i + 1} , {x}_{i} , {u}_{i} , {A}_{0}^{i} , {A}_{1}^{i} , {C}^{i} ) \qquad Eq . 33$$

for the time interval, [tₖ, tₖ₊₁], with k=i using the fast marching algorithm to obtain A₀^{k}, A₁^{k} and C^{k}. The fast marching algorithm can use A₀^{k}′+δA₀^{k}′+δA₁^{k}′(t), and C^{k}′+δCk′t as initial values to start it off (where k′ indicates the previous frame).
3. Determine the time interval such that the data does not vary too much; i.e., find the largest j>1 such that

|xᵢ₊ⱼ−xᵢ|≦εₓ

|uᵢ₊ⱼ−uᵢ|≦εᵤ Eq. 34
for the length of the kth I-frame interval. The threshold values, εₓ and εᵤ can be computed by optional sampling criteria determined by the precision of the data. This may be calculated a priori.
4. Evaluate the coefficients at the beginning of the kth I-frame,

$$\begin{matrix}\begin{matrix}{Y}_{k} = {\tilde{φ}}_{t = 0}^{2} ( {F}_{k} , δ {A}_{0}^{k} ( 0 ) , δ {A}_{1}^{k} ( 0 ) , δ {C}^{k} ( 0 ) ) \\ = {φ}_{k}^{2} ( {t}_{k + 1} , {t}_{k} , {x}_{k + 1} , {x}_{k} , {u}_{k} , {A}_{0}^{{k}^{′}} + δ {A}_{0}^{{k}^{′}} ( t ) , \\ {A}_{1}^{{k}^{′}} + δ {A}_{1}^{{k}^{′}} ( t ) , {c}^{{k}^{′}} + δ {C}^{{k}^{′}} ( t ) )\end{matrix} & \\ and & \\ {Z}_{k} = [ {Z}_{k , 1} , {Z}_{k , 2} , {Z}_{k , 3} ] = {{[ \frac{\partial {\tilde{φ}}_{t}^{2}}{\partial {A}_{0}} \vert}_{{F}_{k}^{-}} , \frac{\partial {\tilde{φ}}_{t}^{2}}{\partial {A}_{1}} \vert}_{{F}_{k}^{-}} , \frac{\partial {\tilde{φ}}_{t}^{2}}{\partial C} {\vert}_{{F}_{k}^{-}} ] & \end{matrix}$$

is calculated as detailed in the Gradient Calculation set out below.
5. Evaluate the rule for computing the following upper and lower bounds, δA₀_{ₘᵢₙ}, δA₀_{ₘₐₓ}, δA₁_{ₘᵢₙ}, δA₁_{ₘₐₓ}, δCₘᵢₙ, and δCₘₐₓ from empirical data.
6. Determine δA₀^{k}(t), δA₁^{k}(t), and δC^{k}(t) using the bang-bang condition, and update the parameters at the end of the kth I-frame; A₀^{k}+δA₀^{k}(T), A₁^{k}+δA₁^{k}(T), and C^{k}+δC^{k}(T). The time at the end of the kth I-frame is T=tᵢ₊ⱼ−tᵢ.
7. If tᵢ₊ⱼ<t_{N}, create another I-frame with k=i+j, and go to Step 2. Otherwise, stop with the final parameter values, A₀^{k}+δA₀^{k}(T), A₁^{k}+δA₁^{k}(T), and C^{k}+δC^{k}(T).

### Gradient Calculation

At the beginning of an I-frame,

$${Z}_{k} = [ {Z}_{k , 1} , {Z}_{k , 2} , {Z}_{k , 3} ] = {{[ \frac{\partial {\tilde{φ}}_{t}^{2}}{\partial {A}_{0}} \vert}_{{F}_{k}^{-}} , \frac{\partial {\tilde{φ}}_{t}^{2}}{\partial {A}_{1}} \vert}_{{F}_{k}^{-}} , \frac{\partial {\tilde{φ}}_{t}^{2}}{\partial C} {\vert}_{{F}_{k}^{-}} ]$$

needs to be evaluated using the parameter values propagated from the previous I-frame, specifically A₀^{k}′+δA₀^{k}′(t), A₁^{k}′+δA₁^{k}′(t), and C^{k}′+δC^{k}′(t). The data values are the values at the I-frame. Thus,

$$\begin{matrix}{{ {Z}_{k , 1} = \frac{\partial {\tilde{φ}}_{k}^{2}}{\partial {A}_{0}} \vert}_{{F}_{k}^{-}} = 2 {\tilde{φ}}_{t = 0} \frac{\partial {φ}_{i}}{\partial {A}_{0}} \vert}_{{F}_{k}^{-}} & Eq . 35 \\ and & \\ {\tilde{φ}}_{t = 0} = {φ}_{k} ( {t}_{k + 1} , {t}_{k} , {x}_{k + 1} , {x}_{k} , {u}_{k} , {A}_{0}^{{k}^{′}} + δ {A}_{0}^{{k}^{′}} ( t ) , {A}_{1}^{{k}^{′}} + δ {A}_{1}^{{k}^{′}} ( t ) , {C}^{{k}^{′}} + δ {C}^{{k}^{′}} ( t ) ) . & Eq . 36\end{matrix}$$

### Similarly,

$$\begin{matrix}{{ {Z}_{k , 2} = \frac{\partial {\tilde{φ}}_{t}^{2}}{\partial {A}_{1}} \vert}_{{F}_{k}^{-}} = 2 {\tilde{φ}}_{t = 0} \frac{\partial {φ}_{i}}{\partial {A}_{1}} \vert}_{{F}_{k}^{-}} and & Eq . 37 \\ {{ {Z}_{k , 3} = \frac{\partial {\tilde{φ}}_{t}^{2}}{\partial C} \vert}_{{F}_{k}^{-}} = 2 {\tilde{φ}}_{t = 0} \frac{\partial {φ}_{i}}{\partial C} \vert}_{{F}_{k}^{-}} . & \end{matrix}$$

The partial derivatives of equation 7 above with respect to A₀, A₁ and C, are given by,

$$\begin{matrix}\frac{\partial {φ}_{i}}{\partial {A}_{0}} = - Δ {t}_{i} {e}^{{A}_{i} Δ {t}_{i}} {x}_{i} - B {e}^{{A}_{i} Δ {t}_{i}} {u}_{i} Δ {t}_{i} - \frac{Cf ( {t}_{i} )}{{A}_{i}^{2}} ( 1 - {A}_{i} Δ {t}_{i} {e}^{- {A}_{i} Δ {t}_{i}} - {e}^{- {A}_{i} Δ {t}_{i}} ) & Eq . 38 \\ \frac{\partial {φ}_{i}}{\partial {A}_{1}} = - Δ {t}_{i} {e}^{{A}_{i} Δ {t}_{i}} {x}_{i} {u}_{i} - B {e}^{{A}_{i} Δ {t}_{i}} {u}_{i}^{2} Δ {t}_{i} - \frac{Cf ( {t}_{i} ) {u}_{i}}{{A}_{i}^{2}} ( 1 - {A}_{i} Δ {t}_{i} {e}^{- {A}_{i} Δ {t}_{i}} - {e}^{- {A}_{i} Δ {t}_{i}} ) & Eq . 39 \\ \frac{\partial {φ}_{i}}{\partial C} = \frac{1}{{A}_{i}} ( 1 - {e}^{- {A}_{i} Δ {t}_{i}} ) f ( {t}_{i} ) & Eq . 40\end{matrix}$$

where Δtᵢ=tᵢ₊₁−tᵢ and Aᵢ=A₀+A₁uᵢ. When evaluating these at F ₖ̅, use the historical data from data store 128, where k=i, for xᵢ₊₁ and xᵢ, the observed demand, the observed order uᵢ, the known index f(tᵢ), and known parameter B. Use the parameter values propagated from the previous I-frame, specifically A₀^{k}′+δA₀^{k}′(t), A₁^{k}′+δA₁^{k}′(t), and C^{k}′+δC^{k}′(t), for A₀, A₁ and C.

It can thus be seen that the present discussion presents a significant technical advantage over prior systems. Technical problems exist in training model parameters in such a way that a forecasting model can accurately forecast items where the model includes a relatively large number of parameters and the historical data to be considered includes data for a relatively long period of time. Solving optimizations in order to obtain such model parameters has conventionally grown exponentially with the number of parameters and the length of time. This significantly slows down the computing system used to generate those parameters. If the model is more complex, it can operate more accurately. However, as the model complexity increases (e.g., as the number of model parameters increase) the computation to generate the model parameter values increases exponentially. Similarly, a model may be more accurate if it considers a higher volume of historical data. However, as the historical data grows, this optimization has tended to grow exponentially as well. The present system advantageously employs a combination of an incremental and a discrete optimization system. Therefore, the data is divided into intervals and the relatively expensive discrete calculations are only performed at the boundaries of those intervals. The less expensive incremental calculations are performed on data between the boundaries to update parameter values for the more expensive calculation at the next interval boundary. This improves the operation of the system itself, because the model parameter values can be evaluated using far less computing overhead and much more quickly. It also facilitates the generation and training of more comprehensive models and thus increases the accuracy of the model itself. It can therefore be deployed in a business system to increase the efficiency of the system, improve the overall operation of the business system and thus the business itself, and to allow users to gain even more comprehensive insights into the dynamics of the organization that uses it.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

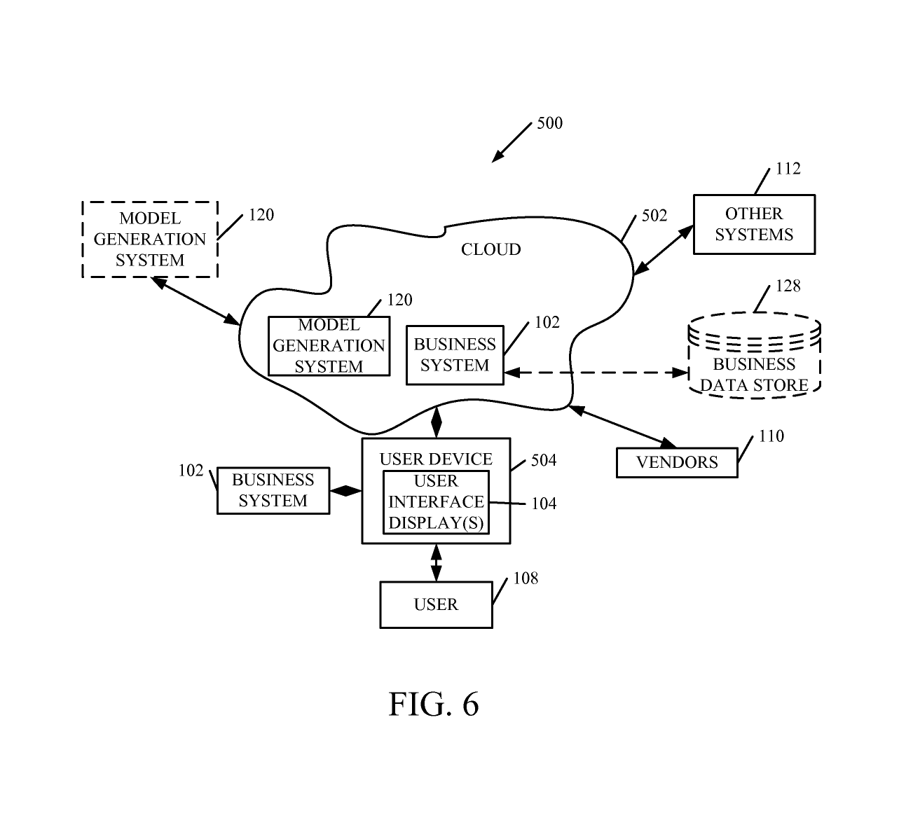

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that both business system 102 and model generation system 120 can be located in cloud 502 (which can be public, private, or a combination where portions are public while others are private). Therefore, user 108 (or 161) uses a user device 504 to access those systems through cloud 502.

FIG. 6 also depicts another example of a cloud architecture. FIG. 6 shows that it is also contemplated that some elements of architecture 100 can be disposed in cloud 502 while others are not. By way of example, data store 128 can be disposed outside of cloud 502, and accessed through cloud 502. In another example, business system 102 is an on premise system, and model generation system 120 is a cloud-based service or another remote service. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

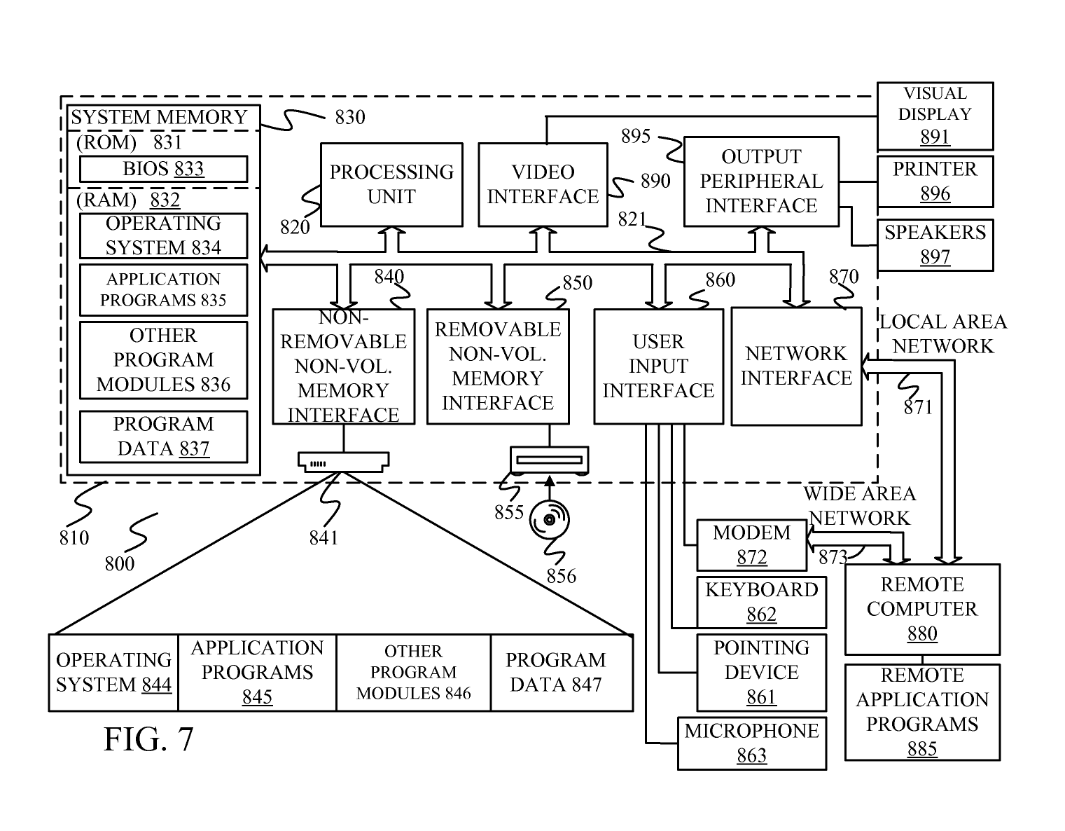

FIG. 7 is one example of a computing environment in which architecture 100, or parts of it, (for example) can be deployed. With reference to FIG. 7, an exemplary system for implementing some embodiments includes a general-purpose computing device in the form of a computer 810. The processors, memories, programs and other items can be used to implement the functionality of model generation system 120 or other items in architecture 100. Components of computer 810 may include, but are not limited to, a processing unit 820 (which can comprise processor 124 or 159), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein with respect to model generation system 120 can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a time interval identifier component that accesses training data in a data store and divides the training data into corresponding time intervals and identifies a time interval, of a plurality of different time intervals, into which the training data is divided;

a boundary evaluation component that is configured to evaluate coefficient values, at a boundary of the time interval, using the training data corresponding to the identified time interval and using model parameter values identified from an immediately previous time interval, for an optimization problem that trains the model parameter values for a model that models a characteristic of the training data; and

an incremental parameter evaluation component that is configured to identify changes in the model parameter values during the time interval and to update the model parameter values based on the changes, the incremental parameter evaluation component providing the updated model parameter values to the boundary evaluation component for evaluation of the coefficient values at a boundary of a next subsequent time interval.

Example 2 is the computing system of any or all previous examples wherein the incremental parameter evaluation component is configured to identify changes in the model parameter values and update the model parameter values during each successive time interval and provide the corresponding updated model parameter values to the boundary evaluation component.

Example 3 is the computing system of any or all previous examples wherein the boundary evaluation component is configured to evaluate the coefficient values at boundaries of each of the successive time intervals using the updated model parameters corresponding to each successive time interval, until all training data corresponding to all time intervals has been processed.

Example 4 is the computing system of any or all previous examples and further comprising:

a data variation threshold generator configured to determine a data variation threshold, the time interval identifier component being configured to divide the training data into time intervals based on training data variation and the data variation threshold.

Example 5 is the computing system of any or all previous examples wherein the training data comprises historical product demand information from a business system and wherein the time interval identifier accesses the historical demand data from a business data store.

Example 6 is the computing system of any or all previous examples wherein the model comprises a demand forecast model that generates demand forecast for products of the business system and further comprising an output component that outputs the demand forecast, with the model parameter values, for deployment at the business system.

Example 7 is a method, comprising:

identifying a time interval, of a plurality of different time intervals, into which training data is divided, the time interval having a first boundary and a second boundary, the second boundary being a first boundary for a next subsequent time interval;

updating model parameter values, for a model that models a characteristic of the training data, based on incremental changes to the model parameter values during the identified time interval;

evaluating coefficient values at the second boundary of the time interval, using the training data corresponding to the identified time interval and using the updated model parameter values from the identified time interval, the coefficient values corresponding to an optimization problem that trains the model parameter values;

repeating the steps of identifying a time interval, updating the model parameter values based on incremental changes, and evaluating coefficient values at the second boundary, for a set of time intervals that covers the training data; and

outputting the model with the updated model parameter values.

Example 8 is the method of any or all previous examples and further comprising:

obtaining a set of data variation threshold values based on a given model precision.

Example 9 is the method of any or all previous examples wherein identifying a time interval comprises:

identifying a given time interval within which the training data varies within the set of data variation threshold values.

Example 10 is the method of any or all previous examples and further comprising:

deploying the model in a business system.

Example 11 is the method of any or all previous examples and further comprising:

generating actionable outputs in the business system, with the model.

Example 12 is The method of any or all previous examples wherein the model comprises a demand forecasting system and wherein generating actionable outputs comprises:

generating a product demand forecast with the demand forecasting model;

providing the product demand forecast to an inventory ordering system; and

generating product purchase orders with the inventory ordering system based on the product demand forecast.

Example 13 is the method of any or all previous examples wherein the model comprises a product demand forecasting model and wherein generating actionable outputs comprises:

generating a product demand forecast for a plurality of different products;

providing the product demand forecast to an assortment planning system; and

generating purchase orders to fulfill an assortment plan generated based on the product demand forecast.

Example 14 is a computer readable storage medium that stores computer executable instructions which, when executed buy a computer, cause the computer to perform a method, comprising:

identifying a time interval, of a plurality of different time intervals, into which training data is divided, the time interval having an initial boundary;

incrementally updating model parameter values, for a model that models a characteristic of the training data, based on changes to the model parameter values during the identified time interval;

evaluating coefficient values at an initial boundary of a next subsequent time interval using the updated model parameter values from the identified time interval, the coefficient values corresponding to a training problem that trains the model parameter values;

repeating the steps of identifying a time interval, updating the model parameter values based on incremental changes, and evaluating coefficient values, for a set of time intervals that covers the training data; and

outputting the model with the updated model parameter values.

Example 15 is the computer readable storage medium of any or all previous examples and further comprising:

obtaining a set of data variation threshold values based on a given model precision, wherein identifying a time interval comprises identifying a given time interval within which the training data varies within the set of data variation threshold values.

Example 16 is the computer readable storage medium of any or all previous examples wherein the training data comprises historical product data in a business system and further comprising:

deploying the model in the business system.

Example 17 is the computer readable storage medium of any or all previous examples and further comprising:

generating business documents in the business system, with the model.

Example 18 is the computer readable storage medium of any or all previous examples wherein the model comprises a demand forecasting system and wherein generating business documents comprises:

generating a product demand forecast with the demand forecasting model;

providing the product demand forecast to an inventory ordering system; and

generating product purchase orders with the inventory ordering system based on the product demand forecast.

Example 19 is the computer readable storage medium of any or all previous examples wherein the model comprises a product demand forecasting model and wherein generating business documents comprises:

generating a product demand forecast for a plurality of different products;

providing the product demand forecast to an assortment planning system; and

generating purchase orders to fulfill an assortment plan generated based on the product demand forecast.

Example 20 is the computer readable storage medium of any or all previous examples wherein identifying a time interval comprises:

identifying a set of varying time intervals based on data variation of the training data over the set of varying time intervals.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a time interval identifier component that accesses training data in a data store and divides the training data into corresponding time intervals and identifies a time interval, of a plurality of different time intervals, into which the training data is divided;
a boundary evaluation component that is configured to evaluate coefficient values, at a boundary of the time interval, using the training data corresponding to the identified time interval and using model parameter values identified from an immediately previous time interval, for an optimization problem that trains the model parameter values for a model that models a characteristic of the training data; and
an incremental parameter evaluation component that is configured to identify changes in the model parameter values during the time interval and to update the model parameter values based on the changes, the incremental parameter evaluation component providing the updated model parameter values to the boundary evaluation component for evaluation of the coefficient values at a boundary of a next subsequent time interval.

2. The computing system of claim 1 wherein the incremental parameter evaluation component is configured to identify changes in the model parameter values and update the model parameter values during each successive time interval and provide the corresponding updated model parameter values to the boundary evaluation component.

3. The computing system of claim 2 wherein the boundary evaluation component is configured to evaluate the coefficient values at boundaries of each of the successive time intervals using the updated model parameters corresponding to each successive time interval, until all training data corresponding to all time intervals has been processed.

4. The computing system of claim 1 and further comprising:
a data variation threshold generator configured to determine a data variation threshold, the time interval identifier component being configured to divide the training data into time intervals based on training data variation and the data variation threshold.

5. The computing system of claim 3 wherein the training data comprises historical product demand information from a business system and wherein the time interval identifier accesses the historical demand data from a business data store.

6. The computing system of claim 5 wherein the model comprises a demand forecast model that generates demand forecast for products of the business system and further comprising an output component that outputs the demand forecast, with the model parameter values, for deployment at the business system.

7. A method, comprising:
identifying a time interval, of a plurality of different time intervals, into which training data is divided, the time interval having a first boundary and a second boundary, the second boundary being a first boundary for a next subsequent time interval;
updating model parameter values, for a model that models a characteristic of the training data, based on incremental changes to the model parameter values during the identified time interval;
evaluating coefficient values at the second boundary of the time interval, using the training data corresponding to the identified time interval and using the updated model parameter values from the identified time interval, the coefficient values corresponding to an optimization problem that trains the model parameter values;
repeating the steps of identifying a time interval, updating the model parameter values based on incremental changes, and evaluating coefficient values at the second boundary, for a set of time intervals that covers the training data; and
outputting the model with the updated model parameter values.

8. The method of claim 7 and further comprising:
obtaining a set of data variation threshold values based on a given model precision.

9. The method of claim 8 wherein identifying a time interval comprises:
identifying a given time interval within which the training data varies within the set of data variation threshold values.

10. The method of claim 7 and further comprising:
deploying the model in a business system.

11. The method of claim 10 and further comprising:
generating actionable outputs in the business system, with the model.

12. The method of claim 11 wherein the model comprises a demand forecasting system and wherein generating actionable outputs comprises:
generating a product demand forecast with the demand forecasting model;
providing the product demand forecast to an inventory ordering system; and
generating product purchase orders with the inventory ordering system based on the product demand forecast.

13. The method of claim 11 wherein the model comprises a product demand forecasting model and wherein generating actionable outputs comprises:
generating a product demand forecast for a plurality of different products;
providing the product demand forecast to an assortment planning system; and
generating purchase orders to fulfill an assortment plan generated based on the product demand forecast.

14. A computer readable storage medium that stores computer executable instructions which, when executed buy a computer, cause the computer to perform a method, comprising:
identifying a time interval, of a plurality of different time intervals, into which training data is divided, the time interval having an initial boundary;
incrementally updating model parameter values, for a model that models a characteristic of the training data, based on changes to the model parameter values during the identified time interval;
evaluating coefficient values at an initial boundary of a next subsequent time interval using the updated model parameter values from the identified time interval, the coefficient values corresponding to a training problem that trains the model parameter values;
repeating the steps of identifying a time interval, updating the model parameter values based on incremental changes, and evaluating coefficient values, for a set of time intervals that covers the training data; and
outputting the model with the updated model parameter values.

15. The computer readable storage medium of claim 14 and further comprising:
obtaining a set of data variation threshold values based on a given model precision, wherein identifying a time interval comprises identifying a given time interval within which the training data varies within the set of data variation threshold values.

16. The computer readable storage medium of claim 14 wherein the training data comprises historical product data in a business system and further comprising:
deploying the model in the business system.

17. The computer readable storage medium of claim 16 and further comprising:
generating business documents in the business system, with the model.

18. The computer readable storage medium of claim 17 wherein the model comprises a demand forecasting system and wherein generating business documents comprises:
generating a product demand forecast with the demand forecasting model;
providing the product demand forecast to an inventory ordering system; and
generating product purchase orders with the inventory ordering system based on the product demand forecast.

19. The computer readable storage medium of claim 17 wherein the model comprises a product demand forecasting model and wherein generating business documents comprises:
generating a product demand forecast for a plurality of different products;
providing the product demand forecast to an assortment planning system; and
generating purchase orders to fulfill an assortment plan generated based on the product demand forecast.

20. The computer readable storage medium of claim 14 wherein identifying a time interval comprises:
identifying a set of varying time intervals based on data variation of the training data over the set of varying time intervals.
